(19) United States
(12) Patent Application Publication
(10) Pub. No.: US 2007/0217502 A1
(43) Pub. Date: Sep. 20, 2007

(54) SWITCHED FILTER UP-SAMPLING MECHANISM FOR SCALABLE VIDEO CODING

(75) Inventors: Nejib Ammar, Irving, TX (US); Marta Karczewicz, Irving, TX (US); Justin Ridge, Irving, TX (US); Xianglin Wang, Palo Alto, CA (US)

Correspondence Address: FOLEY & LARDNER LLP, P.O. BOX 80278, SAN DIEGO, CA, 92138-0278, US

(73) Assignee: Nokia Corporation

(21) Appl. No.: 11/621,951

(22) Filed: Jan. 10, 2007

Related U.S. Application Data
(60) Provisional application No. 60/757,819, filed on Jan. 10, 2006.

(51) Int. Cl. H04B 1/66

(52) U.S. Cl. 375/240.1; 375/240.29

(57) ABSTRACT

An improved switched filter up-sampling mechanism for scalable video coding. A filter switching mechanism of the present invention takes advantage of the best performance of each of the filters in a collaborative manner. The switching process of the present invention can be generalized to more filter choices and potentially relieve the computational complexity due to the added freedom and flexibility of filter choices.

### FIELD OF THE INVENTION

The present invention relates generally to the field of video coding. More particularly, the present invention relates to spatial scalability in scalable video coding (SVC).

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Digital video includes ordered sequences of images produced at a constant rate (for example, 15 or 30 images/second). The resulting amount of raw video data is therefore extremely large. Consequently, video compression is particularly necessary to efficiently code the video data prior to storage or transmission. The compression process is a reversible conversion of video data into a compact format that can be represented with fewer bits.

Video coding commonly exploits the spatial and temporal redundancies inherent in the video sequences for intra and interframe coding. During interframe coding, the encoder attempts to reduce the temporal redundancies between consecutive video frames by predicting the current frame based on its neighboring frames. In intraprediction, the spatial redundancies are reduced by predicting blocks that constitute a frame from their neighboring blocks. After prediction, a residual frame, which is the difference between the predicted and the original frame, is produced alongside some supporting parameters. This residual frame is often compressed prior to transmission, where a transformation, such as the Discrete Cosine Transform (DCT), is applied, followed by variable length coding methods such as Huffman coding.

To allow for more flexibility and adaptation to a variety of applications and transmission bandwidth, scalable video coding extends the basic (single-layer) video coding to multi-layer video coding. Essentially, a base layer is coded together with different enhancement layers at different spatial, temporal and quality resolutions. In addition to inter and intra frame prediction techniques, scalable video coding develops interlayer prediction mechanisms that exploit the redundancies among layers and reuse information from the lower layers.

For the purpose of re-using the information from the reconstructed lower spatial resolution base layer into the higher spatial resolution enhancement layer, an up-sampling of the base layer picture is required. The up-sampling process involves interpolating the pixel values using a finite impulse response filter to generate the higher resolution picture. The quality of the interpolated picture, and therefore the fidelity of the prediction, is clearly influenced by the choice of the up-sampling filter. FIG. 1 provides an example of this requirement, where a simple dyadic interpolation (i.e., up-sampling) is illustrated. The choice of the up-sampling filter plays a crucial role in the overall quality of the compressed enhancement layer. There are currently two conventionally-known alternative filters considered for utilization in SVC—the AVC filter and an optimal filter. While the optimal filter performs relatively well in comparison to the AVC filter at lower bit rates, it underperforms at high bit rates.

JVT's MPEG's Scalable Video Coding project is a scalable extension of H.264/AVC which is currently in the development stage. The corresponding reference encoder is described in ISO/IEC JTC1/SC29/WG11, “Draft of Joint Scalable Video Model JSVM-4 Annex G”, JVT document JVT-Q201, Poznan, July 2005, incorporated herein by reference in its entirety. In the current JSVM, the up-sampling of base layer frames is carried out using the advanced video coding (AVC) filter. Additionally, new optimal filters have been proposed as alternatives to the AVC filter. Such filters are discussed, for example, in Andrew Segall, “Adaptive Study of Up-sampling/Down-sampling for Spatial Scalability”, JVT-Q083, Nice, France, October 2005 (incorporated herein by reference). Each of these competing filters yield relatively good performance at certain bit rates while under-performing at others.

In the current JSVM software, the AVC filter with filter taps [0 0 1 0-5 0 20 32 20 0-5 0 1 0 0]/32 is utilized to up-sample the base layer frames. An optimal filter with filter taps that vary according to the base layer QP (for example when QP_base=20, the taps are given by [0 3 3-8-8 21 42 21-8-8 3 3 0]/32) has previously been proposed as an alternative to the AVC filter in order to further enhance the quality of the interpolated picture. The enhancement achieved by the alternative filter is however limited to the low bit rate cases. Moreover, a decline in performance is observed at high bit rates.

### SUMMARY OF THE INVENTION

The present invention enhances the existing base layer image up-sampling system for usage in scalable video coding. The present invention involves the use of a filter switching mechanism to take advantage of the best performance of each of the filters in a collaborative manner. The switching process of the present invention can be generalized to more filter choices and potentially relieve the computational complexity due to the added freedom and flexibility of filter choices. In the event that the base layer quantization parameter (QP) (QP_base) is fixed, the present invention can be implemented using QP-based switching, rate-distortion-based switching, or filter training based switching. If the base layer QP (QP_base) at the decoder side is not exactly known, then the switching process can be implemented based upon QP thresholds either at a sequence level or at a frame level.

From a performance point of view, the present invention enables the encoder to combine the advantages of the several alternative filters in a collaborative fashion. This performance advantage is illustrated in FIG. 2. The system and method of the present invention can achieve the collective performance gains of the participating filters with the proper switching decisions.

Additionally, because the usage of a single filter irrespective of the data rate may mandate a larger number of filter taps to achieve a decent performance (such as in the case of the optimal filters), the computational complexity of the up-sampling operation can be reduced by using a switching filter mechanism that employs filters with a fewer number of taps. The invention can be implemented directly in software using any common programming language, e.g., C/C++ or assembly language. The present invention can also be implemented in hardware and used in consumer devices.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an illustration of an example of dyadic interpolation of a base layer spatial resolution to obtain an up upper spatial layer frame;

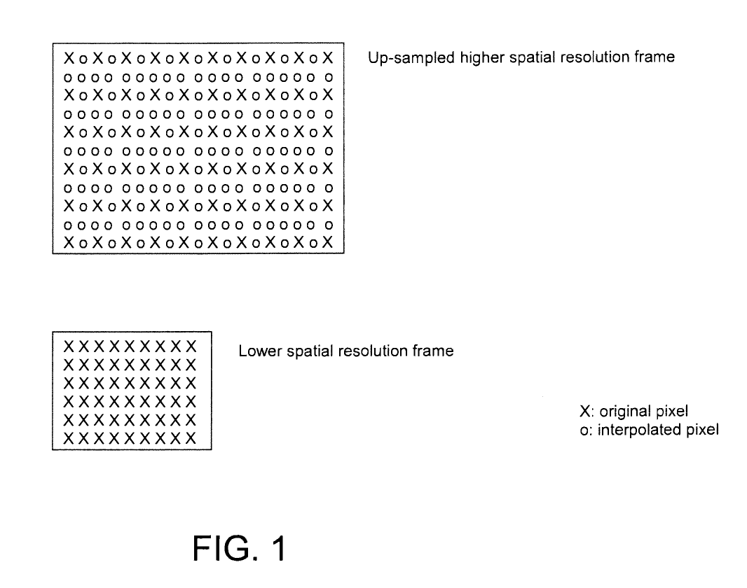

FIG. 2 is an illustration of the performance of the switching mechanism using the AVC and an optimal filter;

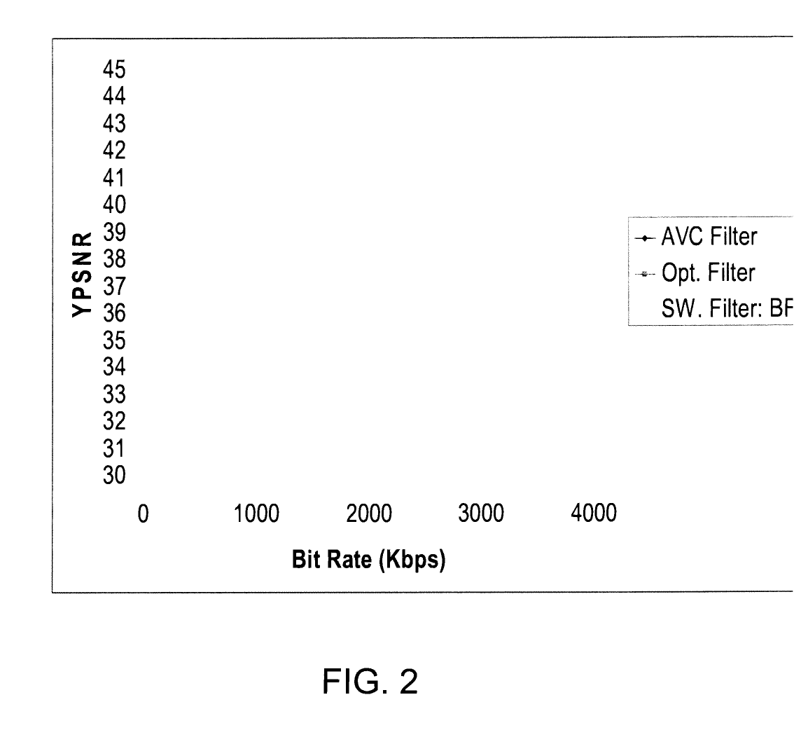

FIG. 3 is an illustration of an up-sampling filter switching mechanism according to the present invention;

FIG. 4 is an illustration showing the formation of QP grid and filter mapping;

FIG. 5 is an overview diagram of a system within which the present invention may be implemented;

FIG. 6 is a perspective view of a mobile telephone that can be used in the implementation of the present invention; and

FIG. 7 is a schematic representation of the telephone circuitry of the mobile telephone of FIG. 6.

### DETAILED DESCRIPTION OF THE PREFERRED EMBODIMENTS

The invention enhances the existing base layer image up-sampling mechanism for usage in scalable video coding. The present invention involves the use of a filter switching mechanism to take advantage of the best performance of each of the filters in a collaborative manner. The switching process of the present invention can be generalized to more filter choices and potentially relieve the computational complexity due to the added freedom and flexibility of filter choices.

To understand the nature of the present invention, it is helpful to consider a lower spatial resolution layer (referred to herein as a spatial base layer), possibly alongside its associated fine grain SNR (FGS) scalable layers. In up-sapling the base layer resolution to obtain the higher spatial resolution (up-sampling QCIF resolution to obtain CIF resolution, for example), the present invention provides for different up-sampling filter switching mechanisms. Some of these mechanisms target the case where the effective QP, at which the lower spatial resolution layer is upsampled at the decoder side, is not exactly known. Others are utilized in the case where this effective QP is exactly known.

In SVC, spatial scalability requires the up-sampling of a lower spatial layer resolution so that its signal can be exploited to predict the upper spatial layer. As discussed above, a single filter is currently used irrespective of the quality level (bit rate) at which the coding is taking place. However, two filters may have different performance strengths at different bit rates. In order to take advantage of best performance of candidate filters, the present invention uses a process that switches between different up-sampling filters.

For describing the present invention in detail, the case of a lower spatial layer (base layer), possibly in conjunction with its different FGS layers, is discussed as follows. The up-sampling can take place either at a fixed lower spatial layer QP, for example when the lower spatial does not have FGS layers, or at an arbitrary lower spatial layer QP. The following, with a known base layer QP and unknown base layer QP, are two basic scenarios for implementing the switched up-sampling process.

Rate-Distortion-Based Switching: Basically, for each enhancement layer frame to be coded, the encoder up-samples the corresponding reconstructed base layer frame using each of the up-sampling filter candidates. The resulting up-sampled frames are individually utilized to code the enhancement layer frame. Subsequently, a rate distortion cost associated with each of the up-sampling filters is calculated. The filter yielding the least rate-distortion cost (and hence its corresponding enhancement layer coded bit stream) is chosen as the best (i.e., final) candidate. The index of the filter of choice is coded into the bit stream. Such a coding may be performed on a per-frame basis, per-macroblock, or other periodic basis. In some cases, signaling may be conditioned on temporally varying characteristics of the video sequence, such as the spectral composition, on spatially varying characteristics, such as spectral differences between one macroblock and an adjacent macroblock, or on other information previously coded into the bit stream, such as the base layer QP value. Such a conditioning may involve selecting a context for entropy coding of the filter index. It may also involve not coding the filter index in some circumstances, for example when the spectral characteristics of one macroblock are similar to the spectral characteristics of a neighboring macroblock for which the filter index is known.

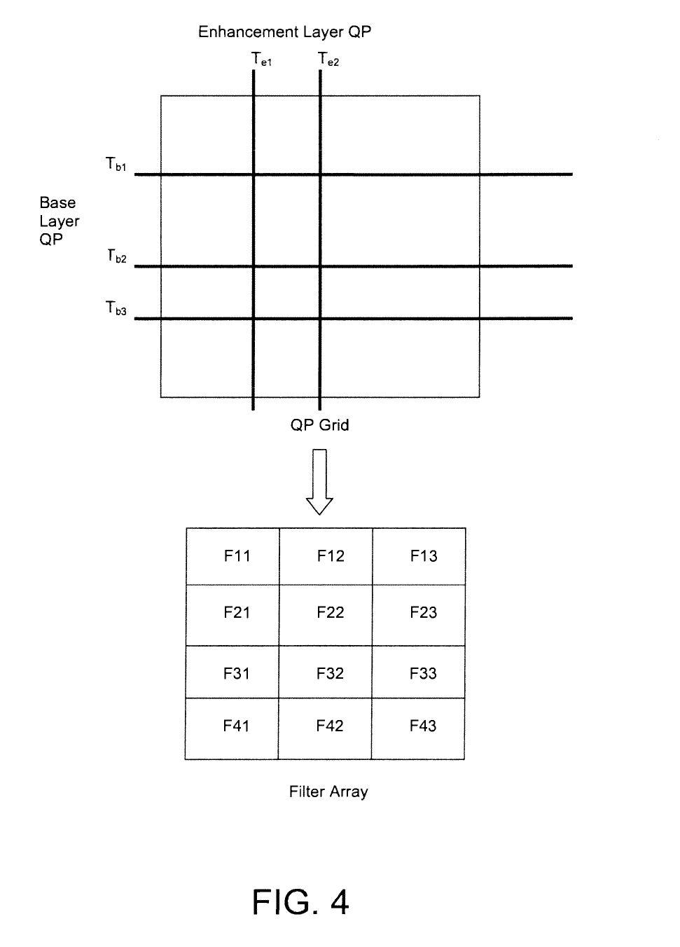

QP-Based Switching. While the previous switching relies on the final coding process outcome corresponding to each of the up-sampling filters to choose the best candidate for a particular enhancement-layer frame, the QP-based switching system selects the best filter among the candidates according to QP thresholds. Essentially, one or more pre-defined constant QP thresholds for QP_base and QP_enhance are set, creating a QP grid of the type shown in FIG. 4. Each cell of the QP grid corresponds to an up-sampling filter choice. Therefore, depending upon where the pair of QP_base and QP_enhance falls on the grid, the encoder chooses one up-sampling filter. The set of QP thresholds are coded into the bitstream. In many cases, the set of QP thresholds are fixed on a sequence basis, but in other cases the thresholds may be coded periodically, or for particular types of frames (e.g. for intra-frames), or their presence may be signaled by a flag bit. In a further enhancement, the coding of the QP thresholds themselves is performed in such a manner so as to take advantage of correlations between neighboring QP thresholds, for example by differentially coding the QP thresholds.

Filter Training Based Switching. In filter training-based switching, the encoder calculates a set of optimal filter coefficients, for example (but not limited to) by optimizing an error signal between the original enhancement resolution frame and the up-sampled frame. The training may be performed independently for a pair of base layer and enhancement layer QP values, or pairs of QP values may be grouped into “classes” with training performed independently for each “class”. While training is generally expected to be performed on a per-frame basis, it may also be performed over other intervals, such as a group of frames or a collection of frames with like type (for example, a set of I-frames or P-frames). The resulting filter taps are then coded into the bit stream. This may be done on a sequence basis, frame basis, or other periodic interval. It may also be triggered by fields in a slice header (such as the slice type), or conditionally coded based upon information previously coded into the bit stream.

When the FGS layer at which the decoder will be decoding the bit stream is not known, the switching mechanism discussed above is modified. A QP-based switching between different filter choices is utilized in two variations—QP-based switching at a sequence level and QP-based switching at a frame level.

For the QP-based switching method at a sequence level, the encoder signals a set of threshold values for QP_base and QP_enhance (clearly at a sequence level). As in the case of a “known base layer QP”, a QP grid is formed based on these threshold values. This QP grid is used to map a given pair of QP_base and QP_enhance to one up-sampling filter choice. Unlike the “known base layer QP” scenario, the encoder and decoder may be using different up-sampling filter if the FGS layer of a lower resolution spatial layer at which the up-sampling is carried is different between both sides of the codec.

In the QP-based switching method at a frame level, because the enhancement layer QP (QP_QP_enhance) is known to both the encoder and the decoder, the encoder signals a set of thresholds for QP_base only on a frame basis. Accordingly, the decoder sets regions for QP_base only, and maps these regions to a vector of up-sampling filters. Depending upon where the effective QP (at which the decoder will be up-sampling the lower spatial layer resolution) falls on the QP regions, the decoder selects an up-sampling filter.

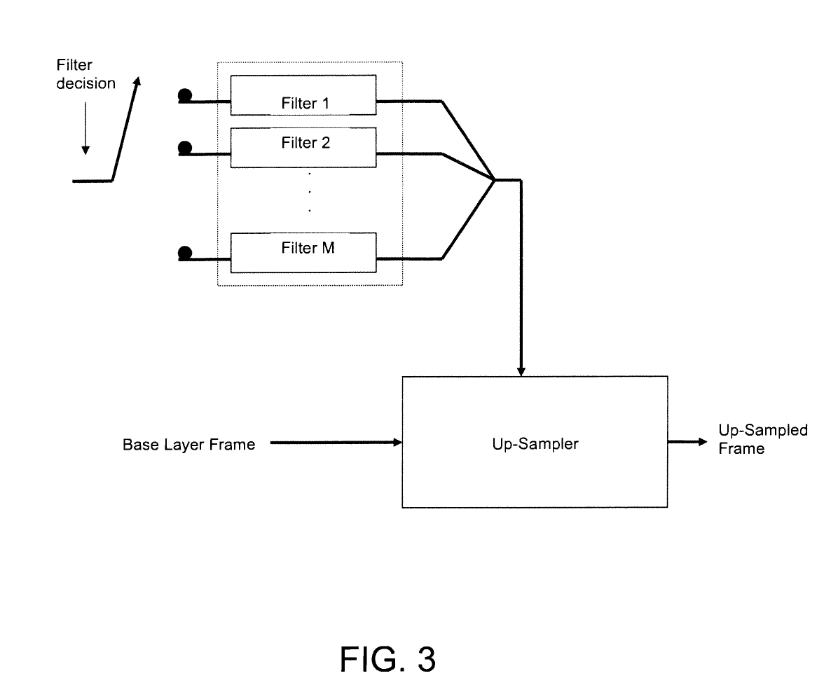

From a performance point of view, the present invention enables the encoder to combine the advantages of the several alternative filters in a collaborative fashion. The present invention can achieve the collective performance gains of the participating filters with the proper switching decisions. As a simple example, FIG. 3 illustrates the performance of the present invention for the football sequence (at 15 fps) using the rate-distortion-based switching between the AVC filter and an optimal filter. The base layer resolution is QCIF (173×144) whereas the enhancement layer resolution is the CIF (352×288). Additionally, because the usage of a single filter, irrespective of the data rate, may mandate a larger number of filter taps to achieve a decent performance (such as the case of the optimal filters), the computational complexity of the up-sampling operation can be reduced by using a switching filter mechanism that employs filters with a fewer number of taps.

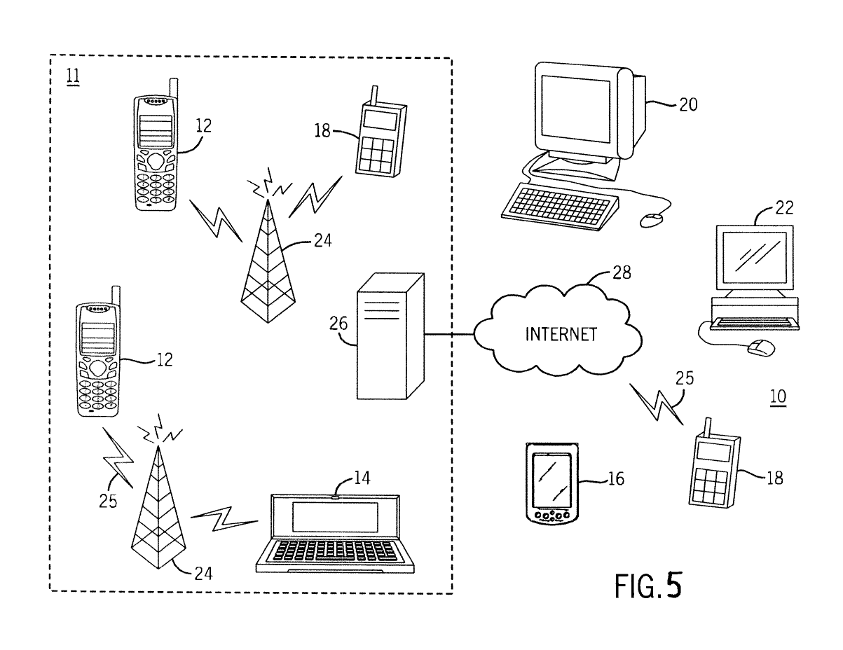

FIG. 5 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 5 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

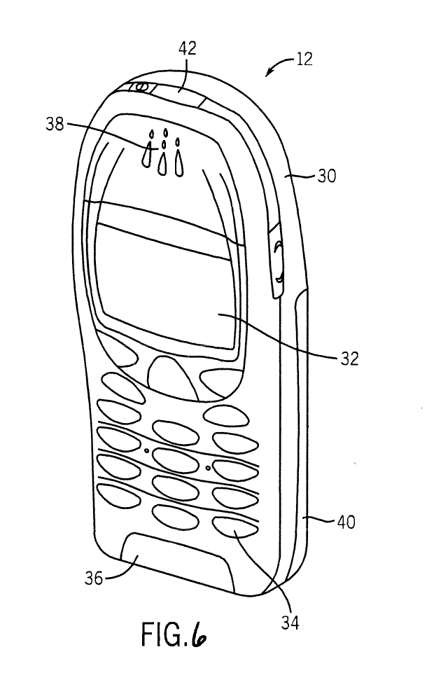

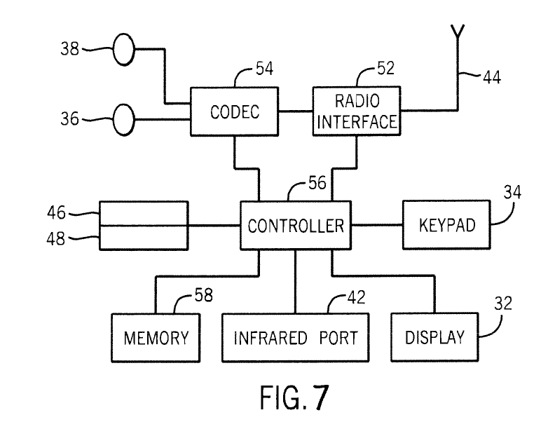

FIGS. 6 and 7 show one representative mobile telephone 12 within which the present invention may be implemented. It should be understood, however, that the present invention is not intended to be limited to one particular type of mobile telephone 12 or other electronic device. The mobile telephone 12 of FIGS. 6 and 7 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

In terms of encoding and decoding, it should be understood that, although text and examples contained herein may specifically describe an encoding process, one skilled in the art would readily understand that the same concepts and principles also apply to the corresponding decoding process and vice versa. Additionally, it should be noted that a bitstream to be decoded can be received from a remote device located within virtually any type of network. Additionally, the bitstream can be received from local hardware or software.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of re-using information from a reconstructed lower spatial resolution layer into a higher spatial resolution enhancement layer, comprising:
providing the reconstructed lower spatial resolution layer; and
up-sampling the reconstructed lower spatial resolution layer to provide a spatial resolution enhancement layer,
wherein the up-sampling of the reconstructed lower spatial resolution layer includes switching among a plurality of filters, in accordance with a predetermined switching process, to filter the reconstructed lower spatial resolution layer.

2. The method of claim 1, wherein the predetermined switching process is dependent upon whether a lower spatial resolution layer quantization parameter is known at a decoder where the up-sampling is to occur.

3. The method of claim 2, wherein the lower spatial resolution layer quantization parameter is known at the decoder, and wherein the switching process comprises a quantization parameter-based switching process, including having an encoder:
utilize a set of thresholds for the lower spatial resolution layer quantization parameter and the higher spatial resolution enhancement layer quantization parameter to select a filter from a plurality of filter candidates, and
signal a set of values for the thresholds to the decoder at a sequence level.

4. The method of claim 2, wherein the lower spatial resolution layer quantization parameter is known at the decoder, and wherein the switching process comprises a rate-distortion based switching process including having an encoder:
select a filter from an indexed set of filter candidates using a rate distortion cost; and
signal the selected filter in the bit stream to the decoder on a frame basis.

5. The method of claim 2, wherein the lower spatial resolution layer quantization parameter is known at the decoder, and wherein the switching process comprises a filter training based switching process including having an encoder:
calculate a set of optimal filter coefficients, resulting in a plurality of filter taps, and
signal the plurality of filter taps to the decoder in the bit stream on a frame basis.

6. The method of claim 2, wherein the lower spatial resolution layer quantization parameter is not known at the decoder, and wherein the switching process is based upon quanitization parameter thresholds at a sequence level.

7. The method of claim 2, wherein the lower spatial resolution layer quantization parameter is not known at the decoder, and wherein the switching process is based upon quanitization parameter thresholds at a frame level.

8. The method of claim 7, wherein the switching process having the encoder signal a set of thresholds for a lower spatial resolution layer quantization parameter for use by the decoder to select a vector of filters depending upon the lower spatial resolution layer quantization parameter of the decoding process.

9. The method of claim 1, wherein the lower spatial resolution layer comprises a base layer.

10. A computer program product, included on a computer-readable medium, for re-using information from a reconstructed lower spatial resolution layer into a higher spatial resolution enhancement layer, comprising:
computer code for providing the reconstructed lower spatial resolution layer; and
computer code for up-sampling the reconstructed lower spatial resolution layer to provide a spatial resolution enhancement layer,
wherein the up-sampling of the reconstructed lower spatial resolution layer includes switching among a plurality of filters, in accordance with a predetermined switching process, to filter the reconstructed lower spatial resolution layer.

11. The computer program product of claim 10, wherein the predetermined switching process is dependent upon whether a lower spatial resolution layer quantization parameter is known at a decoder where the up-sampling is to occur.

12. The computer program product of claim 11, wherein the lower spatial resolution layer quantization parameter is known at the decoder, and wherein the switching process comprises a quantization parameter-based switching process, including having an encoder:
utilize a set of thresholds for the lower spatial resolution layer quantization parameter and the higher spatial resolution enhancement layer quantization parameter to select a filter from a plurality of filter candidates, and
signal a set of values for the thresholds to the decoder at a sequence level.

13. The computer program product of claim 11, wherein the lower spatial resolution layer quantization parameter is known at the decoder, and wherein the switching process comprises a rate-distortion based switching process including having an encoder:
select a filter from an indexed set of filter candidates using a rate distortion cost; and
signal the selected filter in the bit stream to the decoder on a frame basis.

14. The computer program product of claim 11, wherein the lower spatial resolution layer quantization parameter is known at the decoder, and wherein the switching process comprises a filter training based switching process including having an encoder:
calculate a set of optimal filter coefficients, resulting in a plurality of filter taps, and
signal the plurality of filter taps to the decoder in the bit stream on a frame basis.

15. The computer program product of claim 11, wherein the lower spatial resolution layer quantization parameter is not known at the decoder, and wherein the switching process is based upon quanitization parameter thresholds at a sequence level.

16. The computer program product of claim 11, wherein the lower spatial resolution layer quantization parameter is not known at the decoder, and wherein the switching process is based upon quanitization parameter thresholds at a frame level.

17. The computer program product of claim 16, wherein the switching process includes having an encoder signal a set of thresholds for a lower spatial resolution layer quantization parameter for use by the decoder to select a vector of filters depending upon the lower spatial resolution layer quantization parameter of the decoding process.

18. The computer program product of claim 10, wherein the lower spatial resolution layer comprises a base layer.

19. A decoder configured to re-use information from a reconstructed lower spatial resolution layer into a higher spatial resolution enhancement layer, comprising:
a processor; and
a memory unit communicatively connected to the processor and including:
computer code for providing the reconstructed lower spatial resolution layer; and
computer code for up-sampling the reconstructed lower spatial resolution layer to provide a spatial resolution enhancement layer,
wherein the up-sampling of the reconstructed lower spatial resolution layer includes switching among a plurality of filters, in accordance with a predetermined switching process, to filter the reconstructed lower spatial resolution layer.

20. The electronic device of claim 19, wherein the predetermined switching process is dependent upon whether a lower spatial resolution layer quantization parameter is known at a decoder where the up-sampling is to occur.

21. The electronic device of claim 20, wherein the lower spatial resolution layer quantization parameter is known at the decoder, and wherein the switching process comprises a quantization parameter-based switching process, the quantization parameter-based switching process being based upon an encoder:
utilizing a set of thresholds for the lower spatial resolution layer quantization parameter and the higher spatial resolution enhancement layer quantization parameter to select a filter from a plurality of filter candidates, and
signaling a set of values for the thresholds to the decoder at a sequence level.

22. The electronic device of claim 20, wherein the lower spatial resolution layer quantization parameter is known at the decoder, and wherein the switching process comprises a rate-distortion based switching process, the rate-distortion based switching process based upon an encoder:
selecting a filter from an indexed set of filter candidates using a rate distortion cost; and
signaling the selected filter in the bit stream to the decoder on a frame basis.

23. The electronic device of claim 20, wherein the lower spatial resolution layer quantization parameter is known at the decoder, and wherein the switching process comprises a filter training based switching process, the filter training based switching process based upon an encoder:
calculating a set of optimal filter coefficients, resulting in a plurality of filter taps, and
signaling the plurality of filter taps to the decoder in the bit stream on a frame basis.

24. The electronic device of claim 20, wherein the lower spatial resolution layer quantization parameter is not known at the decoder, and wherein the switching process is based upon quanitization parameter thresholds at a sequence level.

25. The electronic device of claim 20, wherein the lower spatial resolution layer quantization parameter is not known at the decoder, and wherein the switching process is based upon quanitization parameter thresholds at a frame level.

26. The electronic device of claim 19, wherein the lower spatial resolution layer comprises a base layer.
